(19) United States
(12) Patent Application Publication
(10) Pub. No.: US 2018/0272997 A1
(43) Pub. Date: Sep. 27, 2018

(54) HEAT SINK AND CLEANING DEVICE

(71) Applicant: GM GLOBAL TECHNOLOGY OPERATIONS LLC, Detroit, MI (US)

(72) Inventor: Brian A. Swain, Sterling Heights, MI (US)

(73) Assignee: GM GLOBAL TECHNOLOGY OPERATIONS LLC, Detroit, MI (US)

(21) Appl. No.: 15/467,543

(22) Filed: Mar. 23, 2017

(51) Int. Cl. B60S 1/56; F28F 3/02; G01S 7/481; G01S 17/93; B60S 1/48; B60S 1/52

(52) U.S. Cl. CPC B60S 1/56; F28F 3/022; B60S 1/52; G01S 17/936; B60S 1/481; G01S 7/4811

(57) ABSTRACT

A heat sink with at least one fluid directing member is disclosed. The heat sink includes a heat collection surface, a heat transfer surface comprising at least one heat dissipation surface, and at least one fluid directing member. Arranging the heat collection surface in operative connection with the heat source causes dissipation of heat from the heat source through the at least one heat dissipation surface. The at least one fluid directing member directs a fluid away from the heat transfer surface and towards an outer surface of the heat source.

### INTRODUCTION

The present invention relates generally to the field of vehicle sensors and, more specifically, to a heat sink and cleaning device for a vehicle sensor.

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

Autonomous vehicles are equipped with a variety of sensors to provide information on the surrounding environment. One type of sensor commonly found on autonomous vehicles is a LIDAR sensor. LIDAR sensors are often mounted on a heat sink to cool the sensor during operation. Operation of the autonomous vehicle during inclement weather can result in droplets or other accumulations that compromise the field of view of the LIDAR sensor and thus compromise performance of the autonomous driving system.

### SUMMARY

Embodiments according to the present disclosure provide a number of advantages. For example, embodiments according to the present disclosure mitigate water and debris accumulation on a lens of a LIDAR sensor. Additionally, embodiments according to the present disclosure use the warm air rejected from the sensor unit to dry the lens of the LIDAR sensor and provide a defogging effect.

In one aspect, a heat sink includes a heat collection surface, a heat transfer surface including at least one heat dissipation surface, and at least one fluid directing member. Arranging the heat collection surface in operative connection with a heat source causes dissipation of heat from the heat source through the at least one heat dissipation surface and the at least one fluid directing member directs a fluid away from the heat transfer surface and towards an outer surface of the heat source.

In some aspects, the heat collection surface includes a mounting surface and the heat transfer surface is separated from the mounting surface by an edge surface.

In some aspects, the at least one fluid directing member is located along and parallel to the edge surface.

In some aspects, the heat collection surface defines a first plane and the heat transfer surface defines a second plane.

In some aspects, the heat transfer surface includes a plurality of heat dissipation surfaces.

In some aspects, the plurality of heat dissipation surfaces at least partially surround the heat collection surface.

In some aspects, the at least one fluid directing member is a cleaning nozzle.

In another aspect, an automotive vehicle includes a body, a heat sink coupled to the body, the heat sink including a heat collection surface, a heat transfer surface including at least one heat dissipation surface, and at least one fluid directing member, and a heat source coupled to the heat sink, the heat source comprising at least one lens. Arranging the heat collection surface in operative connection with the heat source causes dissipation of heat from the heat source through the at least one heat dissipation surface and the at least one fluid directing member directs a fluid toward the at least one lens of the heat source such that the fluid passes against an outside surface of the at least one lens to clear the surface of the at least one lens.

In some aspects, the heat collection surface defines a first plane separate from a second plane defined by the heat transfer surface.

In some aspects, the heat collection surface is separated from the heat transfer surface by an edge surface.

In some aspects, the at least one fluid directing member is located along and parallel to the edge surface.

In some aspects, the heat transfer surface includes a plurality of heat dissipation surfaces.

In some aspects, the plurality of heat dissipation surfaces at least partially surround the heat collection surface.

In some aspects, the heat source is a LIDAR sensor and the heat source is coupled to the heat collection surface of the heat sink.

In some aspects, the at least one fluid directing member is a cleaning nozzle.

In some aspects, the automotive vehicle further includes a controller configured to generate a control signal to trigger the release of the fluid from the at least one fluid directing member.

In some aspects, the automotive vehicle further includes a fluid reservoir fluidicly coupled to the at least one fluid directing member.

### BRIEF DESCRIPTION OF THE DRAWINGS

The present disclosure will be described in conjunction with the following figures, wherein like numerals denote like elements.

FIG. 1 is a schematic block diagram of a vehicle having at least one sensor and a sensor mounting device, according to an embodiment.

FIG. 2 is a schematic top perspective view of a sensor mounting device, according to an embodiment.

FIG. 3 is a schematic side view of the sensor mounting device of FIG. 2.

FIG. 4 is a schematic top perspective view of a sensor mounting device and a LIDAR sensor, according to an embodiment.

FIG. 5 is a schematic side view of the sensor mounting device and LIDAR sensor of FIG. 4.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

Sensors, such as but not limited to, LIDAR sensors, are used by autonomous vehicles to assess the surrounding environment. LIDAR sensor units are typically mounted inside a shroud for protection. Shrouded LIDAR sensor units generally include an internal heat transfer mechanism, such as a heat sink, but shrouded units often need an additional method of heat transfer, such as, for example and without limitation, an external heat sink.

The field of vision of a LIDAR unit may be compromised in wet driving conditions by condensation, precipitation, or debris on the lens of the unit. For example, water or other liquid on the lens of the LIDAR sensor unit can imped the laser signals that are sent out by the sensor to read the environment. LIDAR lens cleaning devices such as those described herein are used to mitigate issues related to compromised fields of view by blowing liquid, such as water, or gas, such as air, over the lens of the unit. The pressure of the liquid or gas removes the condensation, precipitation, or debris off of the lens and allows the LIDAR unit to regain field of vision. Blowing liquid droplets or other debris off the lens of the unit improves and/or maintains the functionality of the sensor unit.

Embodiments discussed herein combine a heat sink with a lens cleaning device. Integration of heat transfer functionality with lens cleaning functionality into a single device reduces build complexity and packaging requirements. Additionally, integrating lens cleaning functionality with a heat sink device allows for greater heat rejection due to the air or other fluid flowing through the device. Additionally, ambient air that is warmed by heat rejected from the sensor unit may also provide benefits including drying and defogging the lens of the LIDAR sensor unit.

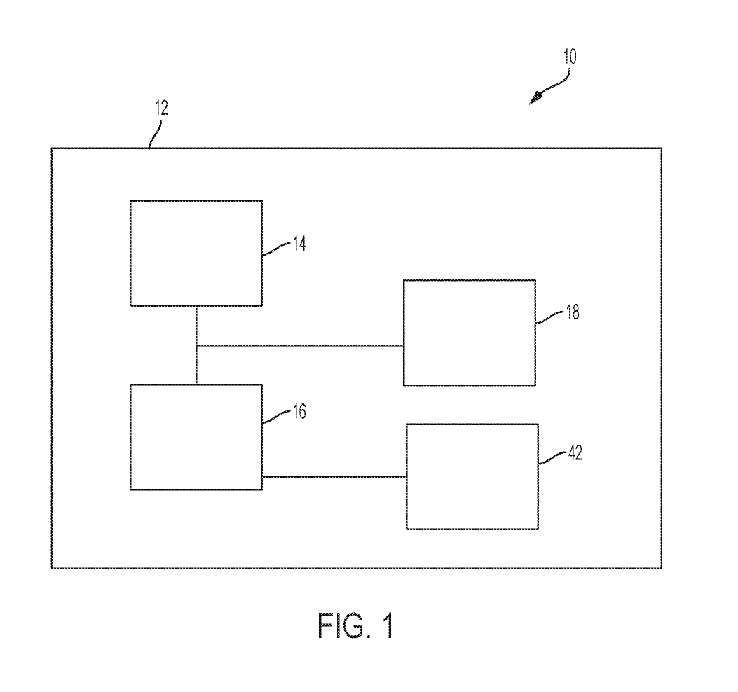

FIG. 1 is a block diagram of a vehicle 10 that includes a body 12. The vehicle 10 also includes at least one sensor 14 configured to measure and capture data on one or more vehicle characteristics, including but not limited to objects or features of the environment surrounding the vehicle and ambient light level conditions. In the illustrated embodiment, the sensors 14 include, but are not limited to, an accelerometer, a speed sensor, a heading sensor, gyroscope, steering angle sensor, or other sensors that sense observable conditions of the vehicle or the environment surrounding the vehicle and may include RADAR, LIDAR, optical cameras, thermal cameras, ultrasonic sensors, infrared sensors, light level detection sensors, and/or additional sensors as appropriate. In some embodiments, one or more of the sensors 14, for example and without limitation, a LIDAR sensor, is mounted on a heat sink and cleaning device 16 as discussed in detail herein.

The vehicle 10 includes at least one controller 18. While depicted as a single unit for illustrative purposes, the controller 18 may additionally include one or more other controllers, collectively referred to as a “controller.” The controller 18 may include a microprocessor or central processing unit (CPU) or graphical processing unit (GPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 18 in controlling the vehicle, including the vehicle sensors.

The sensor 14 is electrically connected to the controller 18. The sensor 14 transmits sensor data to the controller 18 and receives control signals from the controller 18. In some embodiments, the cleaning device 16 is also electrically connected to the controller 18. The cleaning device receives control signals from the controller 18, including a control signal to trigger the release of fluid from a cleaning nozzle of the cleaning device. In some embodiments, the cleaning device 16 transmits device data to the controller 18. In some embodiments, a fluid reservoir 42 is fluidicly coupled to the device 16. As described in greater detail herein, in some embodiments, the device 16 receives a control signal from the controller 18 indicating a desired release of fluid from the device 16. In some embodiments, in response to the control signal, the device 16 draws fluid from the fluid reservoir 42 or from the external environment.

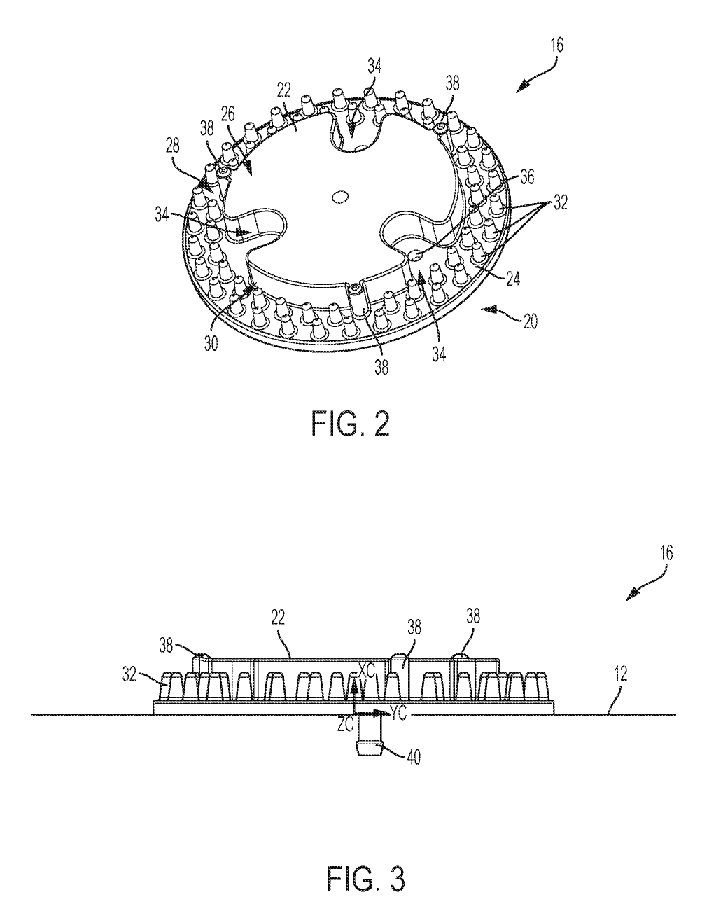

FIGS. 2 and 3 illustrate a heat sink and cleaning device 16 for a vehicle sensor, such as a LIDAR sensor, according to an embodiment. As discussed above, in some embodiments, one or more sensors 14, including one or more LIDAR sensors, are mounted on one or more devices 16. The device 16 includes a body 20. As shown in FIG. 2, the body 20 is substantially circular. However, in other embodiments, the body 20 could be any other shape, such as, for example and without limitation, square, rectangular, oval, etc. The body 20 includes an upper portion 22 and a lower portion 24. The upper portion 22 includes an upper or mounting surface 26. The upper surface 26 is also a heat collection surface. One of the sensors 14, such as a LIDAR sensor, may be coupled to the upper surface 26, as discussed in greater detail herein. In some embodiments, the upper surface 26 is substantially circular; however, in other embodiments, the upper surface 26 could have a rectangular, oval, or square shape, for example and without limitation.

The lower portion 24 includes a lower surface 28. The lower surface 28 is a heat transfer surface that includes at least one heat dissipation surface. In some embodiments, the lower surface 28 is substantially circular. However, in other embodiments, the lower surface 28 could have a rectangular, oval, or square shape, for example and without limitation. The heat collection or upper surface 26 defines a first plane and the heat transfer or lower surface 28 defines a second plane. In some embodiments, the first and second planes are substantially parallel. The upper surface 26 and the lower surface 28 are connected by an edge surface 30. The edge surface 30 is perpendicular to or substantially perpendicular to each of the surfaces 26, 28. In some embodiments, the upper portion 22 and the lower portion 24 are a single piece. In some embodiments, the upper portion 22 and the lower portion 24 are separately formed and joined together by any means including, for example and without limitation, welding, screwing, bolting, etc.

A plurality of heat dissipation surfaces 32 extend from and are substantially perpendicular to the lower surface 28. In some embodiments, the plurality of heat dissipation surfaces 32 at least partially surround the heat collection or upper surface 26. As discussed in greater detail herein, the heat generated by operation of the sensor, such as a LIDAR sensor, is transferred through the upper surface 26 and/or the lower surface 28 and dispelled via the heat transfer members 32.

At least one fluid directing member 38 extends along the edge surface 30. In some embodiments, the fluid directing member 38 is substantially parallel to the edge surface 30. The at least one fluid directing member 38 is substantially perpendicular to the lower surface 28. In some embodiments, the device 16 includes a plurality of fluid directing members 38 approximately equally distributed around the perimeter of the upper surface 26. The device 16 illustrated in FIG. 2 has three (3) fluid directing members 38; however, other embodiments include more or fewer fluid directing members 38.

The fluid directing member 38 includes an opening at the end of the member 38 opposite the lower surface 28 such that the fluid directing member 38 has a nozzle-like shape. As discussed in greater detail herein, the fluid directing member 38 directs a fluid, such as, for example and without limitation, air, water, or a cleaning solution, away from the lower surface 28 and towards and along an outer surface of the lens of the sensor mounted to the upper surface 26 of the device 16.

In some embodiments, the device 16 includes a fluid supply port 40, as shown in FIG. 3. The fluid supply port 40 is fluidicly connected to the fluid directing members 38 and to the fluid reservoir 42. When the device 16 receives a control signal from the controller 18 indicating a cleaning operation is to be performed, fluid travels from the fluid reservoir 42 via the fluid supply port 40 to the fluid directing members 38. The fluid is directed by the fluid directing members 38 along the outer surface of the lens of the sensor 14 mounted to the device 16 to remove droplets or debris from the outer surface of the lens.

In some embodiments, the edge surface 30 defines a plurality of recesses 34. Three (3) recesses 34 are shown in FIG. 2; however, other embodiments could include more or fewer recesses 34. In some embodiments, mounting holes 36 are formed through the lower surface 28. In some embodiments, at least a portion of the mounting holes 36 are located within the recesses 34. FIG. 2 clearly shows one mounting hole 36; however, similar mounting holes 36 may be located in each of the recesses 34. In some embodiments, the mounting holes 36 extend through the lower surface 28 at any position on the lower surface 28. In some embodiments, mechanical fasteners, such as, for example and without limitation, screws or bolts, pass through the holes 36 to couple the device 16 to a surface, such as, for example and without limitation, an exterior surface of a vehicle body 12.

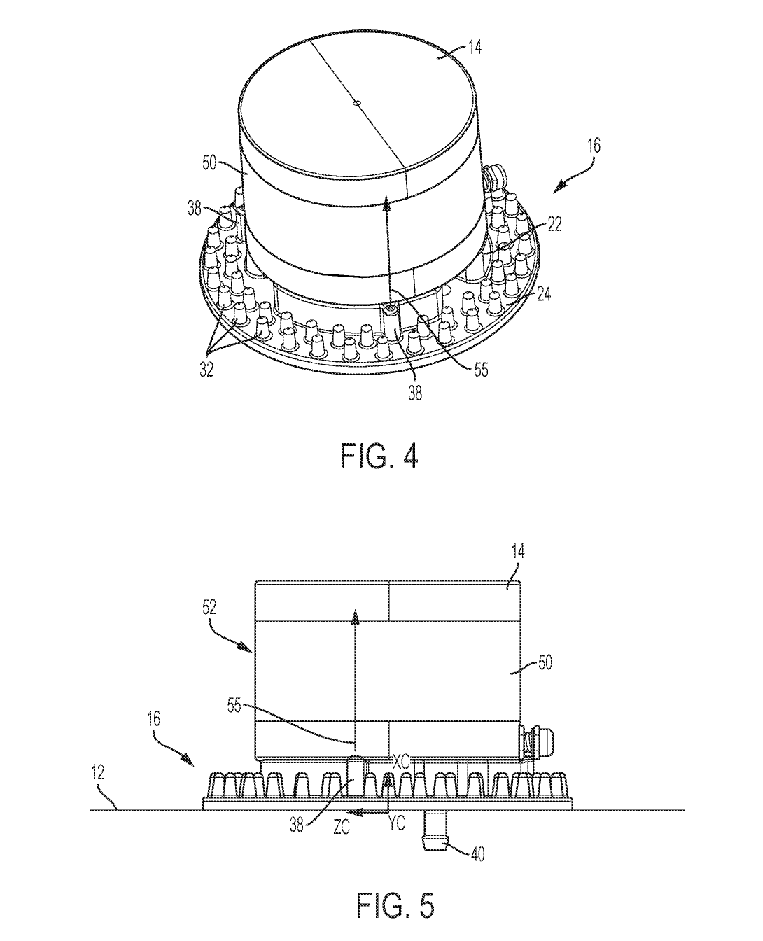

FIGS. 4 and 5 illustrate the heat sink and cleaning device 16 of FIGS. 1 and 2 with a vehicle sensor 14 mounted to the device, according to an embodiment. In some embodiments, the vehicle sensor is a LIDAR sensor. The sensor 14 includes a lens 50 having an outer surface 52. In some embodiments, the outer surface 52 is the outer surface of a shroud enclosing the LIDAR sensor 14. For example and without limitation, fluid, such as air, supplied to the device 16 via the fluid supply port 40, enters the device 16 and is routed to the fluid directing members 38. The fluid is directed away from the lower portion 24 of the device 16 through the nozzle end of the fluid directing member 38 along the outside surface 52 of the lens 50 in the direction indicated by arrow 55 to remove liquid droplets or other debris from the outside surface 52.

Heat generated by the sensor 14 is transferred through the upper and lower portions 22, 24 of the device 16 and is released to the surrounding environment via the plurality of heat dissipation surfaces 32. Arranging the heat collection or upper portion 22 in operative connection with the sensor 14 causes dissipation of heat from the sensor through the heat dissipation surfaces 32 of the heat transfer or lower portion 24. In some embodiments, the heat generated by the sensor 14 during operation warms the fluid that is expelled from the fluid directing members 38. The warm fluid, for example, warm air, is directed by the fluid directing member 38 as shown by arrow 55 and at least partially dries the surface 52 of the lens 50 as it passes over the surface. Additionally, the warm air provides a defogging effect on the outer surface 52 of the lens 50 to improve sensor functionality during operation conditions in which condensation forms on the outer surface 52 of the lens 50.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A heat sink, comprising:
a heat collection surface;
a heat transfer surface comprising at least one heat dissipation surface; and
at least one fluid directing member;
wherein arranging the heat collection surface in operative connection with a heat source causes dissipation of heat from the heat source through the at least one heat dissipation surface and wherein the at least one fluid directing member directs a fluid away from the heat transfer surface and towards an outer surface of the heat source.

2. The heat sink of claim 1, wherein the heat collection surface comprises a mounting surface and the heat transfer surface is separated from the mounting surface by an edge surface.

3. The heat sink of claim 2, wherein the at least one fluid directing member is located along and parallel to the edge surface.

4. The heat sink of claim 1, wherein the heat collection surface defines a first plane and the heat transfer surface defines a second plane.

5. The heat sink of claim 1, wherein the heat transfer surface comprises a plurality of heat dissipation surfaces.

6. The heat sink of claim 5, wherein the plurality of heat dissipation surfaces at least partially surround the heat collection surface.

7. The heat sink of claim 1, wherein the at least one fluid directing member is a cleaning nozzle.

8. An automotive vehicle, comprising:
a body;
a heat sink coupled to the body, the heat sink comprising a heat collection surface, a heat transfer surface comprising at least one heat dissipation surface, and at least one fluid directing member; and
a heat source coupled to the heat sink, the heat source comprising at least one lens;
wherein arranging the heat collection surface in operative connection with the heat source causes dissipation of heat from the heat source through the at least one heat dissipation surface and wherein the at least one fluid directing member directs a fluid toward the at least one lens of the heat source such that the fluid passes against an outside surface of the at least one lens to clear the surface of the at least one lens.

9. The automotive vehicle of claim 8, wherein the heat collection surface defines a first plane separate from a second plane defined by the heat transfer surface.

10. The automotive vehicle of claim 8, wherein the heat collection surface is separated from the heat transfer surface by an edge surface.

11. The automotive vehicle of claim 10, wherein the at least one fluid directing member is located along and parallel to the edge surface.

12. The automotive vehicle of claim 8, wherein the heat transfer surface comprises a plurality of heat dissipation surfaces.

13. The automotive vehicle of claim 12, wherein the plurality of heat dissipation surfaces at least partially surround the heat collection surface.

14. The automotive vehicle of claim 8, wherein the heat source is a LIDAR sensor and the heat source is coupled to the heat collection surface of the heat sink.

15. The automotive vehicle of claim 8, wherein the at least one fluid directing member is a cleaning nozzle.

16. The automotive vehicle of claim 8 further comprising a controller configured to generate a control signal to trigger the release of the fluid from the at least one fluid directing member.

17. The automotive vehicle of claim 8 further comprising a fluid reservoir fluidicly coupled to the at least one fluid directing member.
